(19) United States
(12) Patent Application Publication
(10) Pub. No.: US 2002/0007486 A1
(43) Pub. Date: Jan. 17, 2002

(54) Multifunctional refrigerator

(75) Inventor: Keyong-Seok Yun, Changwon City (KR)

Correspondence Address: FLESHNER & KIM, LLP, P.O. Box 221200, Chantilly, VA, 20153-1200, US

(73) Assignee: LG Electronics Inc.

(21) Appl. No.: 09/878,373

(22) Filed: Jun. 12, 2001

(30) Foreign Application Priority Data
Jun. 19, 2000 (KR) 2000-33707

(51) Int. Cl. H04N 7/16; H04N 7/173

(52) U.S. Cl. 725/26; 725/105

(57) ABSTRACT

The present invention relates to a multifunctional refrigerator, and more particularly, to a multifunctional refrigerator capable of preventing private information from being leaked through external hacking in the refrigerator which can communicate images with an external device. The multifunctional refrigerator of the present invention is constructed to selectively drive a camera signal processing portion and a microphone signal processing portion which are provided for an image communicating function, and thus, information inside the houses can be prevented from being leaked to the outside. The selective drive of the camera signal processing portion and the microphone signal processing portion is carried out by controlling electric power supplied thereto. It is constructed such that the control of the supplied power can be made only by a manual switch mounted in the refrigerator and not by a control signal through an external communication means.

### FIELD OF THE INVENTION

The present invention relates to a multifunctional refrigerator, and more particularly, to a multifunctional refrigerator capable of preventing private information from being leaked through external hacking in the refrigerator which can communicate images with an external device.

Refrigerator is a freezing device for preserving foods, cooking materials or the like as long as possible. Such a freezing device regulates a temperature inside the device by means of high temperature and pressure refrigerant that circulates in a freezing cycle provided in the device so that the foods are kept and preserved without being spoiled. That is, in the refrigerator, cold air is generated by the freezing cycle provided in the device, and controlled so that the generated cold air is supplied to the refrigerator based on the temperature inside the refrigerator. Therefore, it is possible to regulate uniformly the temperature inside the refrigerator.

As above, the basic function of the refrigerator is to uniformly regulate the temperature inside the refrigerator.

On the other hand, networking systems have been recently introduced to many houses and companies. Household electric appliances having various functions have been developed by taking advantage of theses networking systems. That is, many consumers demand household electric appliances and electronic devices having convenient and various functions, and such products are, in fact, being developed.

### BACKGROUND OF THE INVENTION

Similarly, these developments are also applied to the refrigerator.

As an example, various functions, such as an alarming function for notifying a user at a certain time using a clock provided in the refrigerator, a filtering function for providing the user with water after purifying the water supplied from an external water source, a function for automatically making ice and filling a freezing tray with it, have been also introduced to the refrigerator.

Such various functions can be integrated into to the refrigerator due to high performance of control devices as the technology has been developed. That is, as a semiconductor technology and similar kinds thereof has been developed, the control devices having high performance have been installed into the refrigerator.

Accordingly, by utilizing these control devices, it is possible to introduce various additional functions to the refrigerator in addition to its basic function. Further, the temperature regulating function, i.e., inherent function of the refrigerator can also be performed to obtain higher efficiency by using less energy. Therefore, the refrigerator has been utilized from various aspects.

### SUMMARY OF THE INVENTION

Taking advantage of such trend, the present invention proposes a refrigerator capable of performing image communications. Particularly, the present invention proposes a refrigerator capable of preventing information in the houses or companies from being leaked through external hacking from the refrigerator which is driven for 24 hours a day.

Accordingly, an object of the present invention is to provide a multifunctional refrigerator which can prevent information on houses from being leaked through external hacking in the refrigerator capable of communicating with the outside.

In order to achieve the object of the present invention, the multifunctional refrigerator according to the present invention comprises an image/voice input and output means installed in the refrigerator for controlling input and output of image and voice signals, a communication means connected to the outside through a communication line for performing data communications of the image and voice signals between the image/voice input and output means and the outside, a selector switch installed on the exterior of the refrigerator for selecting as to whether to supply electric power to the image/voice input and output means by a user; and a power supply control means for switching operating power source of the image/voice input and output means in accordance with a select signal of the selector switch.

The multifunctional refrigerator according to the present invention may further comprise a control means for controlling transmission of the image and voice signals between the image/voice input and output means and the communication means.

The multifunctional refrigerator according to the present invention may further comprise a storage means for storing the image and voice signals inputted from the image/voice input and output means, and electric power supplied to the storage means may also be controlled by the power source control means.

The image/voice input and output means according to the present invention may comprise a camera lens for taking a picture of an object, a camera signal processing portion for signal processing a photographed signal of the camera lens, a microphone for inputting the voice signal, a microphone signal processing portion for signal processing the signal inputted from the microphone, a speaker for outputting the voice signal, and a display screen for displaying the image signal.

The power source control means according to the present invention may cut off the electric power supplied to the camera signal processing portion and the microphone signal processing portion.

### BRIEF DESCRIPTION OF THE DRAWINGS

FIG. 1 is a perspective view of a multifunctional refrigerator according to the present invention.

FIG. 2 is a constitutional view of a multifunctional refrigerator according to the present invention.

### DETAILED DESCRIPTION FOR PREFERRED EMBODIMENT

Hereinafter, a multifunctional refrigerator according to the present invention will be explained in detail with reference to the accompanying drawings.

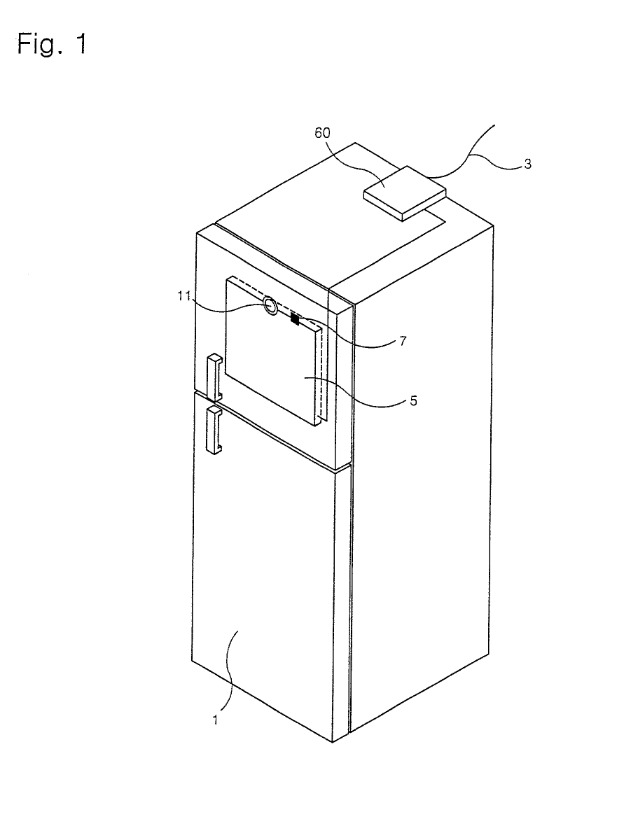

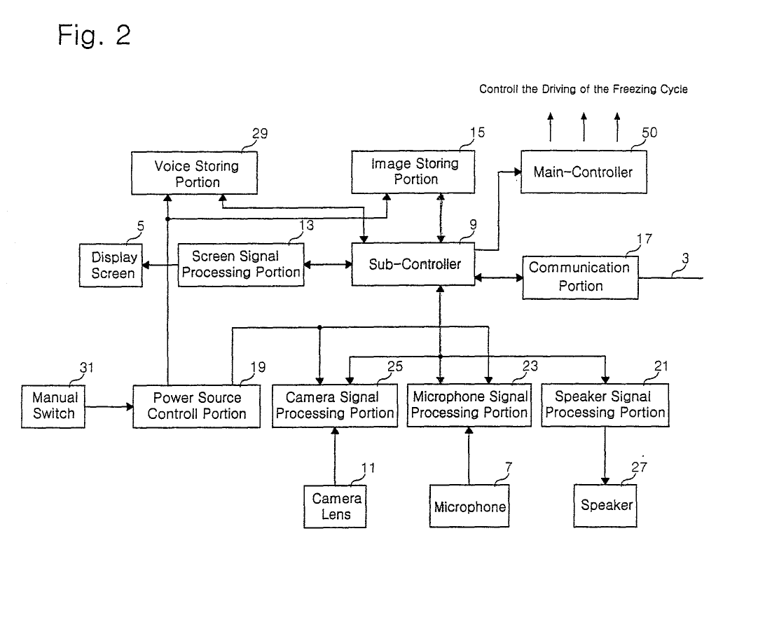

FIG. 1 is a perspective view of the multifunctional refrigerator according to the present invention, and FIG. 2 is a constitutional view of the multifunctional refrigerator according to the present invention.

The multifunctional refrigerator of the present invention is provided with a constitution of a freezing cycle for generating cold air. Further, a main controller 50 for controlling the freezing cycle is provided. That is, the main controller 50 controls automatically supply of the cold air to the refrigerator based on the set temperature inside the refrigerator, while controlling the driving of the freezing cycle. Since the constitution for controlling the freezing cycle by means of the main controller 50 is same as the control constitution for the conventional freezing cycle, detailed explanation regarding thereto will be omitted. The main controller 50 carries out necessary data communication with a sub-controller to be described later.

In addition, the multifunctional refrigerator of the present invention has a constitution for taking a picture of a user by means of a camera lens 11.

That is, as shown in FIG. 1, a display screen 5 for enabling video communications is installed in a front face of the refrigerator 1. The camera lens 11 for taking a picture is also installed in one side of the front face of the refrigerator 1. Further, a camera signal processing portion 25 for processing image signals that are taken by the camera lens 11 is provided and is controlled by the sub-controller 9 to be described later.

Accordingly, the image of the user photographed by the camera lens 11 is signal processed by the camera signal processing portion 25, and what is displayed in the display screen 5 is then controlled or transmitted to the outside. Furthermore, there is provided an image storing portion 15 for storing the processed image signals in the form of the image, and there is also provided a screen signal processing portion 13 for processing the image signals in order to display the image corresponding thereto on the display screen 5.

Moreover, the sub-controller 9 for controlling the constitutional components is included in the present invention. The sub-controller 9 controls the display of the image photographed by the camera lens 11 onto the display screen 5 or storage of the image in the image storing portion 15. It is also possible to control an output of the image to the outside. Furthermore, it is possible to output it using an external device.

Additionally, the multifunctional refrigerator of the present invention has a function for inputting a voice of the user through a microphone 7.

It is preferred that the microphone 7 be installed in the front face of the refrigerator in order to facilitate recording the user's voice, as shown in FIG. 1. A microphone signal processing portion 23 for processing the voice signal inputted through the microphone 7 is also provided.

The voice signal inputted as such through the microphone 7 is outputted to the outside through a communication means or stored after it has been processed in the microphone signal processing portion 23. Accordingly, the refrigerator of the present invention is provided with a voice storing portion 29 for storing the user's voice. Further, all the constitutional components are controlled by the sub-controller 9.

Moreover, the multifunctional refrigerator of the present invention has a communication function for communicating with the outside.

That is, as shown in FIG. 1, a communication line 3, which is connected to the external communication line, is connected to the refrigerator 1; and the communication line 3 is then connected to the sub-controller 9 through a communication portion 17.

Accordingly, when the image signal of an object that is seen through the camera lens 11 is to be transmitted to the outside, the image signal from the camera lens 11 is transmitted to the outside through the communication portion 17 under the control of the sub-controller 9.

In addition, the signal received through the communication portion 17 is displayed on the display screen 5 under the control of the sub-controller 9.

Furthermore, the voice signal of the user, which is inputted through the microphone 7, is transmitted to the outside through the communication portion 17 under the control of the sub-controller 9. On the contrary, the voice signal received through the communication portion 17 is outputted through a speaker 27 to be described later, under the control of the sub-controller 9.

That is, the present invention further comprises a function for outputting the voice signal received from the outside. To this end, the multifunctional refrigerator of the present invention comprises the speaker 27 and a speaker signal processing portion 21 for outputting the voice signal to the speaker 27. The speaker signal processing portion 21 is also controlled by the sub-controller 9.

In the foregoing, the constitution of the refrigerator capable of performing image communications will be explained.

However, taking account into the fact that the refrigerator is an electric appliance that operates for 24 hours a day, a constitution for forcibly controlling the external communication function should be included in the refrigerator.

That is, since the refrigerator generally operates for 24 hours a day in most cases, it is in a state that electric power is always supplied to respective components inside the refrigerator. Therefore, external hackers can hack the image and voice information in the house by infiltrating to the sub-controller 9 in the refrigerator. Accordingly, the refrigerator having a communication function according to the present invention should include a constitution for preventing the information in houses or companies from being leaked by the external hackers.

To this end, the present invention further comprises a voice storing portion 29 for storing voice signals, an image storing portion 15 for storing images, a camera signal processing portion 25 for signal processing the images taking pictures of several users in houses or companies, a power supply controlling portion 19 that can control operating electric power supplied to a microphone signal processing portion 23 for processing the voice signals of the users in houses and companies. In addition, the present invention further comprises a manual switch 31 for manually controlling the operation of the power source control portion 19 by the user. Accordingly, it is preferred that the manual switch 31 be installed on a side of the exterior of the refrigerator.

The control of the power supply controlling portion 19 by the manual switch 31 is performed by controlling the electric power applied to the voice storing portion 29, the image storing portion, the camera signal processing portion 25 and the microphone signal processing portion 23 upon request of the user.

Further, the power source control portion 19 is controlled only by the users by means of the manual switch 31. That is, the power source control portion 19 should be installed so that it cannot be controlled by the sub-controller 9.

This is why the sub-controller 9 is connected to the outside through the communication portion 17. Therefore, it is possible to give commands on system control through the sub-controller 9 from the outside. Particularly, since the circumstances in the houses can be monitored through the camera and microphone, the switching operation of the operating power applied to the camera signal processing portion 25 and the microphone signal processing portion 23 should be made only by the manual operations of the users.

Although it is not shown in the drawings, a key input portion for inputting key signals, etc. upon request of the users and transmitting them to the sub-controller 9 is included in the present invention.

If the communication function in the refrigerator is to be completely inoperable by the control of the power source control portion 19, provision of the constitution for controlling the electric power supplied to the communication portion 17 will be sufficient. In this case, the communication function of the refrigerator is completely cut off. On the contrary, the aforementioned constitution for turn off the electric power supplied to the camera signal processing portion 25, the microphone signal processing portion 23, the voice storing portion and the image storing portion is to merely prevent internal information from being leaked to the outside.

Most of the electronic circuits shown in FIG. 2 are mounted on one PCB substrate. A component designated by the reference number 60, which is mounted on an upper portion of the refrigerator shown in FIG. 1, indicates the PCB substrate with the electronic circuits mounted thereon.

Next, the procedures for achieving image communications using the multifunctional refrigerator, constructed as such, according to the present invention will be explained.

While the electric power is supplied to the refrigerator, a freezing cycle is driven and the supply of the cold air into the refrigerator is controlled under the control of the main controller 50.

The image communications with the outside under the operating state of the refrigerator is carried out as follows.

The sub-controller 9 displays the image data, inputted from the outside through the communication portion 17, onto the display screen 5. Of course, this display at this time is carried out after the image data are processed by the screen signal processing portion 13 so that it can be displayed on the display screen 5.

The voice signals received through the communication portion 17 are transmitted to the speaker signal processing portion 21 under the control of the sub-controller 9, and it is then outputted to the speaker 27 through a process such as demodulation in the speaker signal processing portion 21. Since the outputted voice signals are heard by the users, image/voice communications can be made together with the image signals that are displayed on the display screen 5.

Further, the sub-controller 9 controls the microphone signal processing portion 23 and processes the voice signals inputted through the microphone. That is, after the voice signals inputted through the microphone 7 have passed through the processes such as modulation and digital signal conversion, they are outputted from a side of the communication portion 17 under the control of the sub-controller 9.

Moreover, by means of the sub-controller 9, the images of the users photographed by the camera lens 11 are transmitted to the communication portion 17 after they are processed in the camera signal processing portion 25. The communication portion 17 converts the voice and image signals, which have been controlled by the sub-controller 9, into signals suitable for the communications, and then, provides them to the other party's through the communication or transmission line 3.

On the other hand, the present invention is constructed such that the electric power supplied to the camera signal processing portion 25, the microphone signal processing portion 23, the voice storing portion 29 and the image storing portion 15 is controlled by the power source control portion 19.

According to this constitution, when it is likely that the information leakage in the house to the outside occurs because of the image communicating function of the refrigerator, the users can beforehand prevent information from being leaked by using the manual switch 31 mounted in the exterior of the refrigerator.

That is, when the users operate the manual switch 31, the power source control portion 19, which is also controlled by the manual switch 31, turns on or off the electric power supplied to the camera signal processing portion 25 and the microphone signal processing portion 23. It also turns on or off the electric power supplied to the voice storing portion 29 and the image storing portion 15.

If a power-off signal for turning off the electric power is applied to the power source control portion 19 by the manual switch 31, the electric power supplied to the camera signal processing portion 25, the microphone signal processing portion 23, the voice storing portion 29 and the image storing portion 15 is turned off. The power cutoff means that the operations of the electronic circuits are controlled into a stationary state.

Accordingly, the image signals of the objects photographed by the camera lens 11 are prevented from being leaked to the outside because of the stationary state of the camera signal processing portion 25. The voice signals inputted through the microphone 7 are also prevented from being leaked to the outside because of the stationary state of the microphone signal processing portion 23. Furthermore, since the electric power supplied to the voice storing portion 29 and the image storing portion 15 is cut off, normal data recording/reading function cannot be made therein.

Namely, the power source control portion 19 is constructed to control the electric power supplied to the camera signal processing portion 25, the microphone signal processing portion, the voice storing portion 29 and the image storing portion 15; and it is also constructed to operate only by the signal from the manual switch 31 and not to be controlled by the sub-controller 9. Therefore, the power source control portion 19 is not under the control of the sub-controller 9.

Accordingly, although the sub-controller 9 has been driven through the communication portion 17 from the outside, the image and voice signals in the houses cannot be leaked through the camera lens 11 and the microphone 7, because the electric power supplied to the camera signal processing portion 25 and the microphone signal processing portion 23 is cut off by users' settings. In the present invention, external eavesdropping can be prevented by such procedures.

In addition, as described in the foregoing, in a case where the electric power supplied to the communication portion 17 is constructed to be cut off by manipulating the manual switch 31, the information leakage to the outside can be prevented since the communication function of the refrigerator is completely inoperable.

Next, the procedure for taking a picture using the multifunctional refrigerator of the present invention will be explained.

When the users intend to take a picture of a specific object using the camera lens 11 mounted on the refrigerator, they send a photographing command to the sub-controller 9 through the key input portion. When the sub-controller 9 receives the command, it outputs a control signal to the camera signal processing portion 25 and controls the camera signal processing portion to be a state where a picture can be taken by the camera lens 11.

The camera signal processing portion 25 photographs the image of the object, which is inputted through the camera lens 11, performing image signal processing thereof, and then outputs the processed signal. The signal outputted from the camera signal processing portion 25 is outputted to the screen signal processing portion 13 through the sub-controller 9.

The screen signal processing portion 13 processes the image signal so that the image of the object photographed through the camera lens 11 can be displayed on the display screen 5 installed on the front face of the refrigerator 1. Through these procedures, the image signal processed in the screen signal processing portion 13 is displayed on the display screen 5; and the procedure for displaying the image of the object, photographed by the camera lens 11, onto the display screen 5 is then finished.

When carrying out such procedures, the users select the specific image displayed on the display screen 5, and thus, the selected image is displayed on the display screen 5 and simultaneously stored in the image storing portion 15 under the control of the sub-controller 9. At this time, the image storing portion 15 selectively stores only the image selected by the user.

By such procedures, a plurality of image data can be stored in the image storing portion 15. Moreover, the image data are allocated and stored in individual addresses, respectively.

Then, upon request of the user, the image data stored in a specific address is controlled by the sub-controller 9 and displayed on the display screen 5 through the screen signal processing portion 13. That is, the users can store the photographed picture image in the image storing portion 15, and display the desired image in a timely manner.

In addition, the sub-controller 9 can control the communication portion 17 so that the image data stored in the image storing portion 15 are transmitted to the external device (not shown) through the communicating portion. That is, upon request of the user, the stored image can be read and be transmitted to the external device through the communication portion 17. Subsequently, the external device can read and output the inputted image.

Furthermore, according to the present invention, the voice signals inputted by the users through the microphone 7 can be controlled to be stored in the voice storing portion 29. The output control of the stored signal through the speaker 27 can be made.

At this time, the signal processing of the voice signals inputted through the microphone 7 is carried out in the microphone signal processing portion 23, whereas the signal processing of the voice signals to be outputted from the speaker 27 is carried out in the speaker signal processing portion 21. In addition, the voice signals processed in the microphone signal processing portion 23 can be stored in the voice storing portion 29 under the control of the sub-controller 9. Furthermore, it is possible to read the signals stored in the voice storing portion 29 and selectively output them through the speaker 27.

Therefore, the multifunctional refrigerator according to the present invention is characterized in that it comprises a camera lens capable of taking a picture of an object and a camera signal processing portion for carrying out the signal processing of an image of the object photographed by the camera lens to have a function for taking the picture thereof.

Further, the multifunctional refrigerator according to the present invention is characterized in that it further comprises an image storing portion capable of storing the photographed image data, and that a plurality of image data can be stored in the image storing portion so as to output the necessary image data on demand when they is required. Therefore, according to the present invention, it is possible to take pictures of the family by using the camera, store them, and use them as an album.

In addition, the multifunctional refrigerator according to the present invention is characterized in that it comprises a display screen for use in image communications. It also comprises a communicating portion and a voice signal input/output means. Therefore, the users can carry out the image communications with the outside using the image communicating portion mounted on the refrigerator.

Particularly, in the present invention, the camera and the microphone can be selectively driven so as to prevent the eavesdropping of the circumstances inside the houses and offices through the image communicating function. It is constructed such that this control can be made only by the users inside the houses, and not by the control signal of the sub-controller, which is inputted through the external communication means. Accordingly, although the present invention has the communicating function with the outside, it can prevent the circumstances and the conversations inside the houses from being leaked to the outside by the hackers through the refrigerator which is driven for 24 hours a day.

As described in the foregoing, the multifunctional refrigerator according to the present invention has a picture-taking function, an image communicating function and an album function for storing the photographed images. Accordingly, there is an advantage in that the user can use the refrigerator in more various aspects. In addition, the present invention has an advantage in that more effective home networking system can be obtained since it comprises a device for preventing the infiltration of the external hacker through the image communicating device mounted in the refrigerator.

Although the present invention has been described in detail with respect to the preferred embodiment of the invention, it should be understood that a person having an ordinary skill in the art to which the present invention pertains can make various modifications and changes to the present invention without departing from the spirit and scope of the invention defined by the appended claims. Therefore, further modifications to the embodiment of the invention will fall within the scope of the invention.

What is claimed is:

1. A multifunctional refrigerator, comprising:
an image/voice input and output means installed in said refrigerator for controlling input and output of image and voice signals;
a communication means connected to the outside through a communication line for performing data communications of said image and voice signals between said image/voice input and output means and said outside;
a selector switch installed on the exterior of said refrigerator for selecting as to whether to supply electric power to said image/voice input and output means by a user; and
a power supply control means for switching operating power source of said image/voice input and output means in accordance with a select signal of said selector switch.

2. The multifunctional refrigerator as claimed in claim 1, further comprising a control means for controlling transmission of said image and voice signals between said image/voice input and output means and said communication means.

3. The multifunctional refrigerator as claimed in claim 2, further comprising a storage means for storing said image and voice signals inputted from said image/voice input and output means, electric power supplied to said storage means being controlled by said power source control means.

4. The multifunctional refrigerator as claimed in claim 3, wherein said image/voice input and output means comprises:
a camera lens for taking a picture of an object;
a camera signal processing portion for signal processing a photographed signal of said camera lens;
a microphone for inputting said voice signal;
a microphone signal processing portion for signal processing said signal inputted from said microphone;
a speaker for outputting said voice signal; and
a display screen for displaying said image signal.

5. The multifunctional refrigerator as claimed in claim 4, wherein said power source control means cuts off the electric power supplied to said camera signal processing portion and said microphone signal processing portion.
